(19) United States
(12) Patent Application Publication
(10) Pub. No.: US 2012/0105543 A1
(43) Pub. Date: May 3, 2012

(54) Inkjet head package, apparatus and method for assembling the same

(75) Inventors: Won Chul Sim, Seongnam (KR); Jae Woo Joung, Suwon (KR); Yong Sik Kim, Hwaseong (KR)

(73) Assignee: SAMSUNG ELECTRO-MECHANICS CO., LTD., Suwon (KR)

(21) Appl. No.: 13/064,985

(22) Filed: Apr. 29, 2011

(30) Foreign Application Priority Data
Nov. 3, 2010 (KR) 10-2010-0108849

(51) Int. Cl. B41J 2/145; B23P 11/00; B23P 21/00

(52) U.S. Cl. 347/40; 29/714; 29/890.1

(57) ABSTRACT

There are provided an inkjet head package, an apparatus and a method for assembling the same. The inkjet head package may include a plurality of inkjet heads each having an ink channel so as to eject ink through a plurality of nozzles formed on one surface thereof, and a frame having one surface to which another surface of the plurality of inkjet heads is fixed while facing the one surface thereof, the frame including an opening for exposing a portion of the another surface disposed therein.

### CROSS-REFERENCE TO RELATED APPLICATIONS

This application claims the priority of Korean Patent Application No. 10-2010-0108849 filed on Nov. 3, 2010, in the Korean Intellectual Property Office, the disclosure of which is incorporated herein by reference.

### BACKGROUND OF THE INVENTION

1. Field of the Invention

The present invention relates to an inkjet head package, an apparatus and a method for assembling the same.

2. Description of the Related Art

In general, an inkjet head is a structure a structure through which ink is discharged in the form of micro-droplets through a small nozzle by converting an electrical signal into physical force. The inkjet head has been widely used in an industrial inkjet printer in recent years.

For example, a circuit pattern is directly formed by ejecting ink, made by melting a metal such as gold, silver, or the like, onto a flexible printed circuit board (FPCB) or is used in industrial graphics, a liquid crystal display (LCD), an organic light emitting diode (OLED), a solar cell, or the like.

In such an inkjet printing process, it is advantageous to use an inkjet head having a wide printing area, a high nozzle density, and a large number of nozzles. However, since a minimum interval should be maintained between the nozzles, the number of nozzles which may be formed in the inkjet head is limited, and as a result, it is difficult to manufacture an inkjet head having a high nozzle density.

Accordingly, an inkjet printer mounted with several to tens of inkjet heads is used so as to implement high-precision and high-resolution printing within a short period of time. In such an inkjet printer, a method of individually aligning the inkjet heads is applied in order to precisely align a plurality of inkjet heads within an error range of several μms. For this, numerous precise stages or jigs, sensors, and the like are additionally required. For example, equipment, including a stage, a jig, a sensor, and the like which can control axes x, y, z, and θ in aligning a single inkjet head is required.

In the case of individually aligning the inkjet heads, the precision of spacing between the inkjet heads may be improved, but since individual inkjet heads should be provided with equipment components, the number of equipment components is also increased when the plurality of inkjet heads are mounted. For example, when 10 inkjet heads are mounted on an inkjet printer, a total of 40 control stages are required, and as a result, the overall amount of equipment on which the inkjet heads are mounted is increased and a control system that controls the equipment is also complicated, to thereby make it difficult to control the equipment.

Further, since the control stage or sensor is a high-priced piece of equipment, the price thereof is correspondingly rapidly increased.

### SUMMARY OF THE INVENTION

An aspect of the present invention provides an inkjet head package, an apparatus and a method for assembling the same that can remarkedly decrease the number of equipment components being mounted in mounting a plurality of inkjet heads on an inkjet printer and simplify a system controlling a mounting operation.

According to an aspect of the present invention, there is provided an inkjet head package including: a plurality of inkjet heads each having an ink channel so as to eject ink through a plurality of nozzles formed on one surface thereof; and a frame having one surface to which another surface of the plurality of inkjet heads is fixed while facing the one surface thereof, the frame including an opening for exposing a portion of the another surface disposed therein.

The plurality of inkjet heads may be arranged such that the centers of nozzle openings of adjacent inkjet heads are offset.

The frame may include a vacuum absorption hole vacuum-absorbing the plurality of inkjet heads onto the frame at the time of fixing the plurality of inkjet heads.

In this case, a horizontal cross-sectional area of a portion of the vacuum absorption hole which is in contact with the plurality of inkjet heads ma be larger than a portion opposite thereto.

The inkjet head package may further include a joining member joining the plurality of inkjet heads to the frame.

The inkjet head package may further include a guide member formed in at least one of the plurality of inkjet heads and the frame to guide locations of the plurality of inkjet heads.

Each of the plurality of inkjet heads may have an alignment mark at the outermost portion of the nozzle.

The plurality of inkjet heads may be longer than the frame by 0.1 to 2 mm.

Meanwhile, according to another aspect of the present invention, there is provided an apparatus for assembling an inkjet head package, the apparatus including: a frame supporting unit supporting a frame; a sensing unit monitoring locations of a plurality of inkjet heads on the frame; and an aligning unit transporting and aligning the plurality of inkjet heads to predetermined locations on the frame on the basis of the positional information of the plurality of inkjet heads transmitted from the sensing unit.

The sensing unit may include: a camera photographing the locations of the plurality of inkjet heads on the frame; and a camera transporting portion transporting the camera to a predetermined location of an inkjet head to be aligned among the plurality of inkjet heads.

The aligning unit may include: a gripper transporting the plurality of inkjet heads onto the frame and moving the corresponding inkjet heads to the predetermined locations on the frame; and a transport stage transporting the gripper on the basis of the positional information of the plurality of inkjet heads transmitted from the sensing unit to align the plurality of inkjet heads to the predetermined locations on the frame.

In this case, the transport stage may include x, y, and θ-axis stages such that the gripper moves the plurality of inkjet heads in a planar manner on the frame.

Further, the apparatus may further include a vacuum holder depressurizing the inner part of the vacuum absorption hole formed in the frame to fix the plurality of aligned inkjet heads to the predetermined locations on the frame.

Meanwhile, according to yet another aspect of the present invention, there is provided a method for assembling an inkjet head package, the method including: transporting a plurality of inkjet heads onto a frame such that an opposite surface to a nozzle forming surface of the plurality of inkjet heads each having an ink channel to eject ink through a plurality of nozzles faces one surface of the frame and a part of the opposite surfaces is exposed through an opening formed in the frame; aligning the plurality of inkjet heads at predetermined locations on the frame; and fixing the plurality of aligned inkjet heads to the frame.

The aligning may include: moving a sensing unit monitoring a location of a target inkjet head to be aligned on the frame among the plurality of inkjet heads to the predetermined location of the target inkjet head; and moving the target inkjet head to the predetermined location on the basis of the positional information of the target inkjet head monitored by the sensing unit.

The fixing may be performed while the plurality of inkjet heads are vacuum-absorbed through a vacuum absorption hole formed in the frame.

The fixing may be performed by bonding the plurality of inkjet heads with an adhesive applied onto one surface of the frame.

The fixing may be performed by screw-joining the plurality of inkjet heads with the frame.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of an inkjet head package according to an exemplary embodiment of the present invention;

FIG. 2 is a plan view viewed from an inkjet head of an inkjet head package according to an exemplary embodiment of the present invention;

FIG. 3 is an exploded perspective view of an inkjet head package according to an exemplary embodiment of the present invention;

FIG. 4 is a schematic cross-sectional view take along line A-A′ of FIG. 1;

FIG. 5 is a schematic configuration diagram of an apparatus for assembling an inkjet head package according to an exemplary embodiment of the present invention; and

FIG. 6 is a flowchart illustrating a method for assembling an inkjet head package according to an exemplary embodiment of the present invention.

### DETAILED DESCRIPTION OF THE PREFERRED EMBODIMENT

Hereinafter, detailed embodiments of the present invention will be described with reference to the accompanying drawings. However, the spirit of the present invention is not limited to the exemplary embodiments and other exemplary embodiments included in other retrogressive inventions or within the spirit of the present invention can be easily proposed by those skilled in the art through adding, modifying, and deleting other components without departing from the same spirit. However, it will be included in the range of the spirit of the present invention.

Further, like or similar reference numerals refer to like elements having the same function within the same spirit shown in the drawings of the exemplary embodiments.

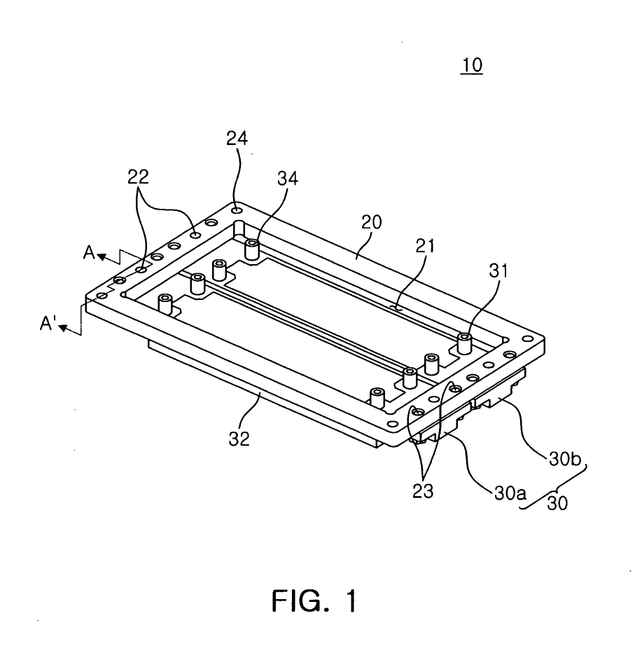

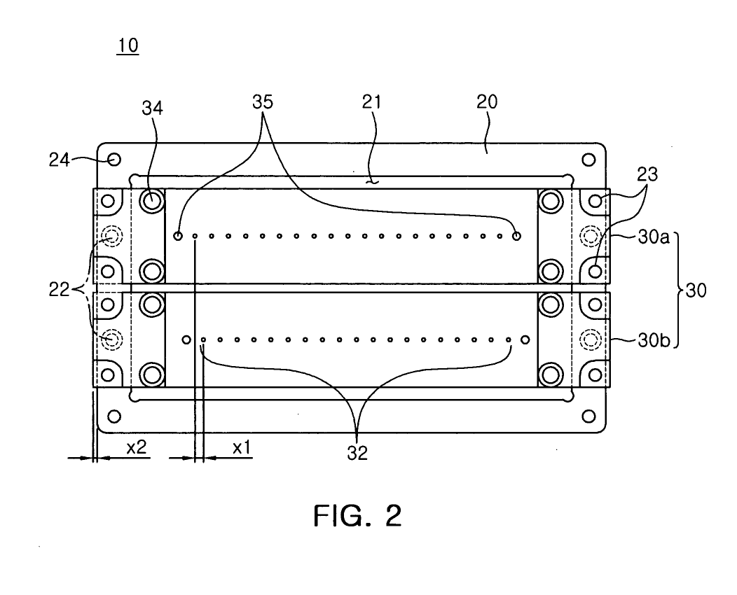

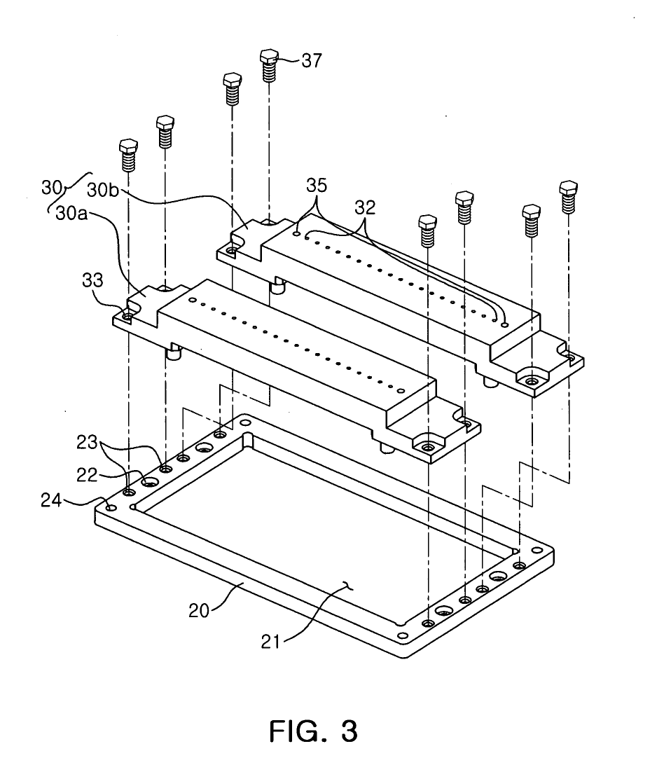

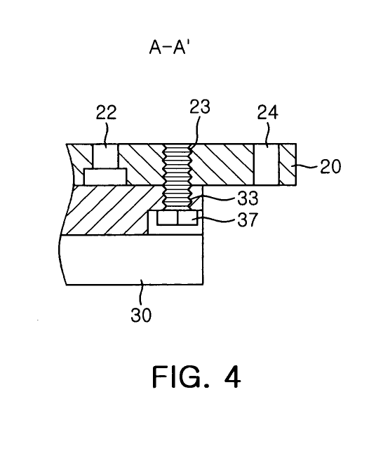

FIG. 1 is a perspective view of an inkjet head package according to an exemplary embodiment of the present invention, FIG. 2 is a plan view viewed from an inkjet head of an inkjet head package according to an exemplary embodiment of the present invention, FIG. 3 is an exploded perspective view of an inkjet head package according to an exemplary embodiment of the present invention, and FIG. 4 is a schematic cross-sectional view take along line A-A′ of FIG. 1.

Referring to FIGS. 1 to 4, the inkjet head package 10 according to the exemplary embodiment of the present invention includes a plurality of inkjet heads 30 each having an ink channel so as to eject ink through a plurality of nozzles formed on one surface thereof and a frame 20 having the plurality of inkjet heads 30 fixed on one surface thereof.

In the exemplary embodiment, a configuration that two inkjet heads 30a and 30b are arranged on the frame 20 is shown and described, but the present invention is not limited thereto. Three or more inkjet heads may be arranged on one frame according to a required condition and a design specification and tens of inkjet heads may be fixed to one frame.

The inkjet head 30 may be constituted by a first inkjet head 30a and a second inkjet head 30b. When the inkjet heads 30 are arranged on the frame 20, the first inkjet head 30a may be a reference head and the second inkjet head 30b may be a target head. That is, the second inkjet head 30b may be arranged based on the first inkjet head 30a. When the number of the inkjet heads arranged on the frame is three or more, an initially arranged inkjet head is the reference head and a subsequently arranged inkjet head is the target head.

Meanwhile, the plurality of nozzles 32 ejecting the ink are formed on one surface of each of the first and the second inkjet heads 30a and 30b and the ink channel is formed in the inkjet head. Herein, it is defined that one surface of the inkjet head is a surface having the nozzles, that is, a surface facing the surface fixed to the frame 20 and the other surface of the inkjet head is a surface facing the surface having the nozzles, that is, the surface fixed to the frame 20.

The inkjet head 30 is a device ejecting the ink into the nozzle depending on a change in pressure or volume in the ink channel due to the driving of an actuator (not shown) and the description of a detailed configuration will be omitted because the detailed configuration is substantially the same as a configuration of a general inkjet head.

In the exemplary embodiment, each inkjet head 30 has a structure in which two unit heads are symmetrical to each other and each of the unit heads includes ink inlets 31 and 34 disposed at both sides thereof in a longitudinal direction, respectively.

Each of the inkjet heads 30 includes through-holes 33 at both ends in a length direction and the through-hole 33 may form a hole into which a joining member 37 is inserted to fix the inkjet head 30 to the frame 20, together with a via-hole 23 formed in the frame 20.

The joining member 37 may be a screw and a thread may be formed on the inner surfaces of the through-hole 33 and the via-hole 23 to which the joining member 37 is screw-joined. That is, the joining member 37 may be a male screw and the hole constituted by the through-hole 33 and the via-hole 23 may be female screws.

Although a case in which screw-joining is used to fix the inkjet head 30 to the frame 20 is shown in the exemplary embodiment, the present invention is not limited thereto and for example, the inkjet head may be fixed to the frame through bonding by applying an adhesive to the frame or the inkjet head.

An alignment mark 35 may be formed on a nozzle forming surface which is one surface of the inkjet head 30 so as to make it easy to align the inkjet head 30 in the frame 20 at the outermost portion of the nozzle 32 in a longitudinal direction of the nozzle forming surface.

The inkjet heads 30 may be disposed such that the centers of nozzle openings of adjacent inkjet heads are offset. That is, as shown in FIG. 2, the center of a nozzle opening of the first inkjet head 30a and the center of a nozzle opening of the second inkjet head 30b may be offset by x1.

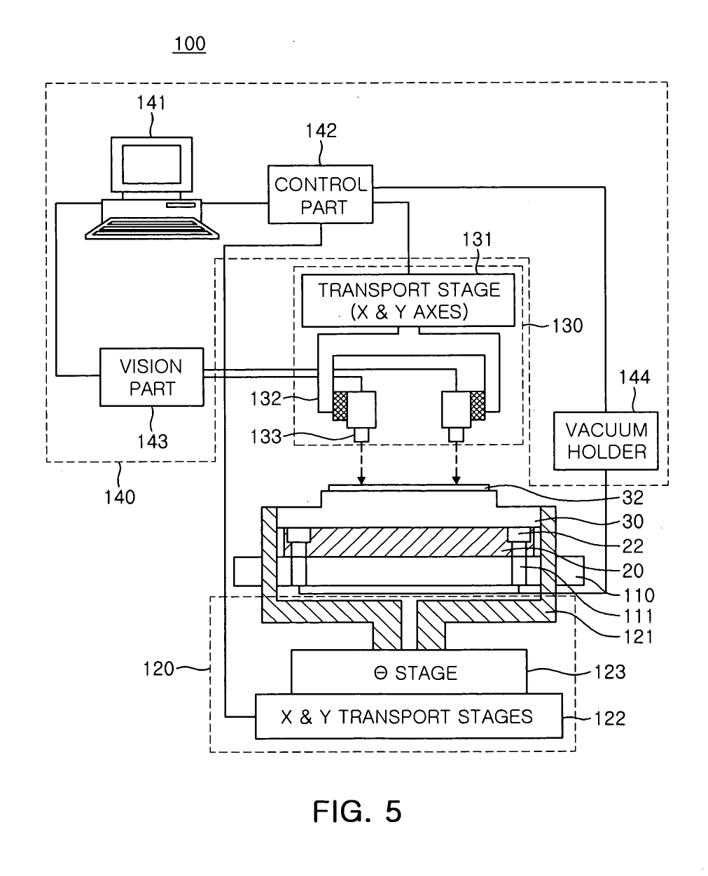

When the inkjet heads 30 are arranged on the frame 20, the inkjet heads 30 may be longer than the frame 20 by 0.1 to 2 mm in a length direction to be easily transported. Referring to FIG. 2, the inkjet head 30 is longer than the frame 20 by x2 in the length direction. The reason is that the inkjet head 30 is moved while being gripped by a gripper 121 (see FIG. 5) at the time of transporting and aligning the inkjet heads 30 on one surface of the frame 20.

The other surface of the inkjet head 30 which is an opposite surface to the nozzle forming surface of the inkjet head 30 is fixed to one surface of the frame 20 while facing one surface of the frame 20, and an opening 21 for exposing a part of the other surface may be formed at the inside of the frame 20.

Although the frame 20 is formed by a quadrangular frame in the exemplary embodiment, the present invention is not limited thereto and frames having various shapes may be used depending on the number and alignment patterns of inkjet heads which are fixed and arranged onto the frame.

The frame 20 includes the via-hole 23 so as to insert the joining member 37 into a portion thereof to which the inkjet head 30 is fixed, and the via-hole 23 has a thread on the inner surface thereof and is linked with the through-hole 33 formed in the inkjet head 30 to constitute the female screw.

The frame 20 may include a vacuum absorption hole 22 vacuum-absorbing the inkjet head 30 such that the inkjet head 30 is fixed onto the frame 30 at the time of fixing the inkjet head 30.

The inner part of the vacuum absorption hole 22 becomes a vacuum state by a vacuum holder 144 (see FIG. 5) at an opposite side to a portion thereof which is in contact with the inkjet head 30, and as a result, the inkjet head 30 may be absorbed to the frame 20. Accordingly, the inkjet head 30 may be fixed onto the frame 20 while the joining member 37 is joined to the through-hole 33 of the inkjet head 30 and the via-hole 23 of the frame 20.

The frame 20 may have a thickness within ±20 μm to facilitate the vacuum absorption of the inkjet head 30, in particular, preferably within ±10 μm.

Further, a horizontal cross-sectional area of a portion of the frame 20 which is in contact with the inkjet head 30 may be larger than an opposite side thereto so as to facilitate the vacuum absorption of the inkjet head 30. The reason is that only a narrow inlet of the vacuum holder causes full absorption while the inner part of the vacuum absorption hole 22 is in the vacuum state by the vacuum holder 144.

In the exemplary embodiment, as shown in FIG. 4, a horizontal cross-sectional area of a portion of the vacuum absorption hole 22 which is in contact with the inkjet head 30 is stepped to be larger than an opposite side thereto, but the present invention is not specifically limited thereto if the horizontal cross-sectional area of the portion of the vacuum absorption hole 22 which is in contact with the inkjet head 30 is larger than the opposite side thereto. For example, the vacuum absorption hole 22 may be inclined such that the horizontal cross-sectional area gradually decreases from the portion thereof which is in contact with the inkjet head toward the opposite side thereto.

The frame 20 may include a guide member 24 that guides the location of the inkjet head 30 at the time of aligning the inkjet head 30. The guide member 24 may be a mark having a predetermined shape and may have various forms such as a form of a hole penetrating the frame 20, a protrusion protruding from an alignment surface of the inkjet head 30 of the frame 20, and the like.

Further, the guide member 24 may be formed in the inkjet head 30 or in both the frame 20 and the inkjet head 30. For example, the guide member 24 may be constituted as a guide pin which protrudes from one surface of the frame 20 and a guide groove formed in the inkjet head 30 for the insertion of the guide pin thereinto, and vice versa. That is, the guide pin may be formed in the inkjet head and the guide groove may be formed in the frame.

In the exemplary embodiment, since the inkjet head package 10 itself may be mounted on the inkjet head package 10 instead of individually mounting the plurality of inkjet heads at the time of mounting the inkjet head package 10 on the inkjet printer, the number of devices installed in the inkjet printer to mount the inkjet head may be remarkedly reduced and a control system for mounting the inkjet head may also be simplified.

For example, in the case in which two inkjet heads are assembled to the inkjet head package 10, components installed in the inkjet printer, particularly, the number of x, y, z, and θ-axis transport stages is reduced half, and as a result, the number of the devices and the device control system may be simplified.

Hereinafter, an apparatus for assembling the inkjet head package according to the exemplary embodiment of the present invention having the above-mentioned configuration will be described.

FIG. 5 is a schematic configuration diagram of an apparatus for assembling an inkjet head package according to an exemplary embodiment of the present invention.

Referring to FIG. 5, the apparatus 100 for assembling an inkjet head package according to the exemplary embodiment of the present invention may include a frame supporting unit 110 supporting the frame 20, an aligning unit 120 transporting and aligning the plurality of inkjet heads 30 to predetermined locations on the frame 20, a sensing unit 130 monitoring the locations of the plurality of inkjet heads 30 on the frame 20, and a control unit 140 controlling transportation and alignment of the plurality of inkjet heads 30.

The frame supporting unit 110 loads the frame 20 to the top surface thereof to support the frame 20 while the inkjet heads 30 are aligned and may include a depressurizing hole 111 which is in communication with the vacuum absorption hole 22 formed in the frame 20 in order to closely attach the inkjet head 30 to the frame 20 at the time of fixing the aligned inkjet heads 30.

The depressurizing hole 111 may be formed at a location corresponding to the vacuum absorption hole 22 by penetrating the frame supporting unit 110 in a thickness direction and the vacuum holder 144 is connected to the depressurizing hole 111 to make the vacuum absorption hole 22 be in the vacuum state when the inkjet head 30 is closely attached to the frame.

The alignment unit 120 may include a gripper 121 that picks up and transports the inkjet head 30 onto the frame 20 and moves it to a predetermined location on the frame 20, and transport stages 122 and 123 that transport the gripper 121.

The transport stages move the gripper 121 on the basis of positional information of the inkjet head 30 transmitted from the sensing unit 130 to align the inkjet head 30 at the predetermined location on the frame 20.

The transport stages may include a first transport stage 122 that plane-moves the inkjet head 30 on one surface of the frame 20 and moves the inkjet head 30 in axes x and y, and a second transport stage 123 that moves the inkjet head 30 in axis θ.

The first transport stage 122 horizontally and vertically moves the inkjet head 30 on one surface of the frame 20 and the second transport stage 123 rotates the inkjet head 30 at a predetermined angle on the basis of a predetermined axis on one surface of the frame 20.

In the exemplary embodiment, since only the x, y, and θ-axis stages are required and the z-axis stage is not required as the transport stage, the volume of the assembling apparatus of the inkjet head package may be reduced and the control system may be simplified.

The sensing unit 130 may include a camera 133 photographing the location of the inkjet head 30 on the frame 20 and camera transporting portions 131 and 132 picking up and moving the camera 133 to a predetermined location of an inkjet head to be aligned among the plurality of inkjet heads 30.

The camera transporting portions 131 and 132 move the camera 133 to an alignment location of the inkjet head 30 and may include a pick-up machine 132 picking up the camera and a transport stage 131 moving the pick-up machine 132. The transport stage 131 may move the camera 133 in x and y-axes directions.

The camera 133 photographs and transmits the alignment mark 35 on the nozzle forming surface of the inkjet head 30 to a vision part 143.

The control unit 140 may include a CPU (central processing unit) 141, a control part 142, a vision part 143 processing image data of the inkjet head 30 photographed by the camera 133, and a vacuum holder 144 vacuum-absorbing the inkjet head 30 to the frame 20.

The vision part 143 processes the image data of the inkjet head 30 photographed by the camera 133 and reads the photographed image and verifies the alignment mark 35 formed on the nozzle forming surface of the inkjet head 30.

The CPU 141 extracts coordinate data of the alignment mark 35 from the image data processed by the vision part 143 as the positional information of the inkjet head 30 and calculates a location correction value of the inkjet head 30 on the basis of the extracted positional information.

The control part 142 controls movement of the first and second transport stages 122 and 123 of the transporting unit 120 on the basis of the location correction value of the inkjet head 30 calculated by the CPU 141, and as a result, the inkjet head 30 may be aligned at a predetermined location.

The control part 142 may control the sensing unit 130. The control part 142 may control the moving of the camera 133 to a predetermined location of an inkjet head to be aligned with the plurality of inkjet heads. In this case, at the location to which the camera 133 will be moved, an alignment mark of the target inkjet head is disposed.

The control part 142 may control the vacuum holder 144. That is, if the location correction value of the inkjet head 30 calculated by the CPU 141 is 0, the inkjet head 30 is aligned at the predetermined location, and as a result, the control part 142 controls the vacuum holder 144 to make the inner parts of the depressurizing hole 111 of the frame supporting unit 110 and the vacuum absorption hole 22 of the frame 20 be in the vacuum state.

Hereinafter, a method for assembling the inkjet head package according to the exemplary embodiment of the present invention having the above-mentioned configuration will be described.

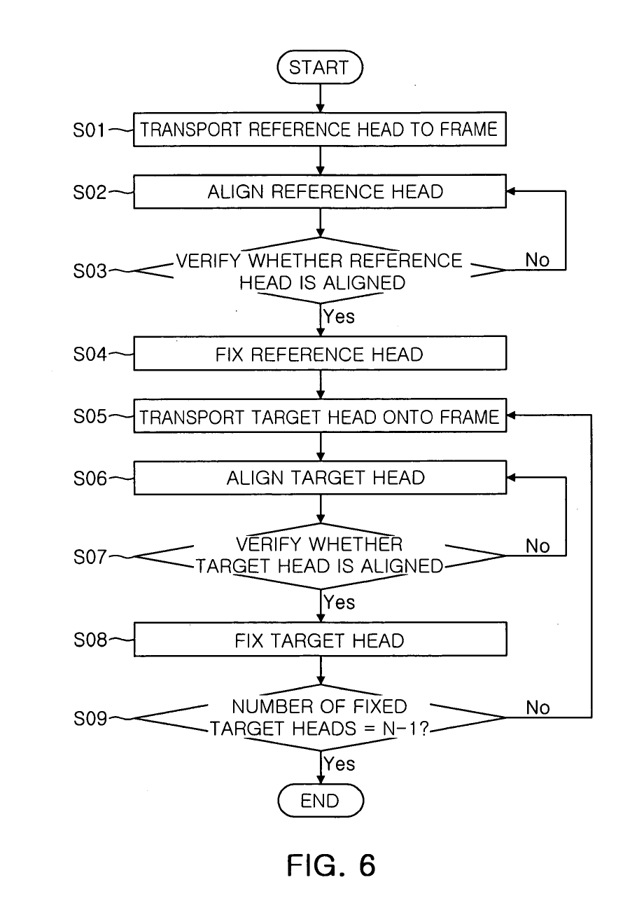

FIG. 6 is a flowchart illustrating a method for assembling an inkjet head package according to an exemplary embodiment of the present invention.

First, in a first operation S01, the inkjet head 30 is transported onto one surface of the frame 20 while the frame 20 is loaded onto the frame supporting unit 110. If the number of inkjet heads 30 to be assembled to the frame 20 is n, an assembling process may be performed by determining an inkjet head initially transported to the frame 20 as a reference head and determining the rest n−1 inkjet heads as target heads. In this case, the camera 133 of the sensing unit 130 is moved to a predetermined location to which the reference head will be aligned. This may be performed before the reference head is transported onto the frame 20 in the first operation S01.

Next, in a second operation S02, the reference head is aligned. That is, the location of the reference head is photographed by the camera 133, a location correction value of the reference head is calculated on the basis of current positional information of the reference head which is extracted from the photographed location of the reference head, and the transporting unit 120 moves the reference head according to the calculated location correction value to align the reference head.

As such, when the reference head is aligned, it is verified whether the reference head is present at the predetermined location in a third operation S03. In detail, the location of the reference head is photographed. If the location correction value of the reference head is 0 on the basis of the positional information of the reference head extracted on the basis of the photographed location of the reference head, it is verified that the reference head is aligned and the process proceeds to the next operation, while if the location correction value is not 0, the process proceeds to the second operation S02 again and the reference head is again aligned according to the location correction value of the reference head.

In the third operation S03, when it is verified that the reference head is aligned, the reference head is fixed to the frame 20 in a fourth operation S04. The reference head may be fixed by applying an adhesive onto one surface of the reference head or the frame and as shown in FIG. 3, the reference head may be fixed by screw-joining.

As such, when the alignment of the reference head is completed, the next inkjet head is transported onto the frame 20 as the target head in a fifth operation S05. In this case, the camera 133 of the sensing unit 130 is moved to a predetermined location to which the target head will be aligned. This may be performed before the target head is transported onto the frame 20 in the fifth operation S05.

Next, the target head is aligned in a sixth operation S06. This may be performed by the same method as alignment of the reference head. That is, the location of the target head is photographed by the camera 133, a location correction value of the target head is calculated on the basis of current positional information of the target head which is extracted from the photographed location of the target head, and the transporting unit 120 moves the target head according to the calculated location correction value to align the target head.

Next, it is verified as to whether the target head is aligned in a seventh operation S07. This may be performed in the same manner as the verification of the alignment of the reference head in the third operation S03. That is, the location of the target head is photographed. If the location correction value of the target head is 0 on the basis of the positional information of the target head, extracted on the basis of the photographed location of the target head, it is verified that the target head is aligned and the process proceeds to the next operation, while if the location correction value is not 0, the process reverts to the sixth operation S06 again and the target head is again aligned according to the location correction value of the target head.

Next, the target head is fixed to the frame 20 in an eighth operation S08. The target head may be fixed by the same method as the fixation of the reference head performed in the fourth operation S04. That is, the target head may be fixed by applying the adhesive onto one surface of the target head or the frame and as shown in FIG. 3, the target head may be fixed by screw-joining.

Next, the number of target heads fixed to the frame 20 is verified in a ninth operation S09. If the number of fixed target heads is equal to the total number of target heads, i.e., n−1, the alignment of the inkjet head is terminated. If the number of fixed target heads is less than n−1, the process proceeds to the fifth operation S05 and the next target head is repetitively aligned and fixed onto the frame.

As described above, when the inkjet head package is assembled by aligning the plurality of inkjet heads on one frame, the inkjet head package itself can be mounted on the inkjet printer.

As set forth above, in the inkjet head package, the apparatus and method for assembling the same according to the exemplary embodiments of the present invention, it is possible to remarkedly decrease the number of equipment components being mounted in mounting a plurality of inkjet heads on an inkjet printer and simplify a system controlling a mounting operation.

While the present invention has been shown and described in connection with the exemplary embodiments, it will be apparent to those skilled in the art that modifications and variations can be made without departing from the spirit and scope of the invention as defined by the appended claims. Accordingly, the scope of the present invention will be determined by the appended claims.

What is claimed is:

1. An inkjet head package comprising:
a plurality of inkjet heads each having an ink channel so as to eject ink through a plurality of nozzles formed on one surface thereof; and
a frame having one surface to which another surface of the plurality of inkjet heads is fixed while facing the one surface thereof, the frame including an opening for exposing a portion of the another surface disposed therein.

2. The inkjet head package of claim 1, wherein the plurality of inkjet heads are arranged such that the centers of nozzle openings of adjacent inkjet heads are offset.

3. The inkjet head package of claim 1, wherein the frame includes a vacuum absorption hole vacuum-absorbing the plurality of inkjet heads onto the frame at the time of fixing the plurality of inkjet heads.

4. The inkjet head package of claim 3, wherein a horizontal cross-sectional area of a portion of the vacuum absorption hole which is in contact with the plurality of inkjet heads is larger than a portion opposite thereto.

5. The inkjet head package of claim 1, further comprising a joining member joining the plurality of inkjet heads to the frame.

6. The inkjet head package of claim 1, further comprising a guide member formed in at least one of the plurality of inkjet heads and the frame to guide locations of the plurality of inkjet heads.

7. The inkjet head package of claim 1, wherein each of the plurality of inkjet heads has an alignment mark at the outermost portion of the nozzle.

8. The inkjet head package of claim 1, wherein the plurality of inkjet heads are longer than the frame by 0.1 to 2 mm.

9. An apparatus for assembling an inkjet head package, the apparatus comprising:
a frame supporting unit supporting a frame;
a sensing unit monitoring locations of a plurality of inkjet heads on the frame; and
an aligning unit transporting and aligning the plurality of inkjet heads to predetermined locations on the frame on the basis of the positional information of the plurality of inkjet heads transmitted from the sensing unit.

10. The apparatus of claim 9, wherein the sensing unit includes:
a camera photographing the locations of the plurality of inkjet heads on the frame; and
a camera transporting portion transporting the camera to a predetermined location of an inkjet head to be aligned among the plurality of inkjet heads.

11. The apparatus of claim 9, wherein the aligning unit includes:
a gripper transporting the plurality of inkjet heads onto the frame and moving the corresponding inkjet heads to the predetermined locations on the frame; and
a transport stage transporting the gripper on the basis of the positional information of the plurality of inkjet heads transmitted from the sensing unit to align the plurality of inkjet heads to the predetermined locations on the frame.

12. The apparatus of claim 11, wherein the transport stage includes x, y, and θ-axis stages such that the gripper moves the plurality of inkjet heads in a planar manner on the frame.

13. The apparatus of claim 9, further comprising a vacuum holder depressurizing the inner part of the vacuum absorption hole formed in the frame to fix the plurality of aligned inkjet heads to the predetermined locations on the frame.

14. A method for assembling an inkjet head package, the method comprising:
transporting a plurality of inkjet heads onto a frame such that an opposite surface to a nozzle forming surface of the plurality of inkjet heads each having an ink channel to eject ink through a plurality of nozzles faces one surface of the frame and a part of the opposite surface is exposed through an opening formed in the frame;
aligning the plurality of inkjet heads at predetermined locations on the frame; and
fixing the plurality of aligned inkjet heads to the frame.

15. The method of claim 14, wherein the aligning includes:
moving a sensing unit monitoring a location of a target inkjet head to be aligned on the frame among the plurality of inkjet heads to the predetermined location of the target inkjet head; and
moving the target inkjet head to the predetermined location on the basis of the positional information of the target inkjet head monitored by the sensing unit.

16. The method of claim 14, wherein the fixing is performed while the plurality of inkjet heads are vacuum-absorbed through a vacuum absorption hole formed in the frame.

17. The method of claim 16, wherein the fixing is performed by bonding the plurality of inkjet heads with an adhesive applied onto one surface of the frame.

18. The method of claim 16, wherein the fixing is performed by screw-joining the plurality of inkjet heads with the frame.
